(19) United States
(12) Patent Application Publication
(10) Pub. No.: US 2005/0165512 A1
(43) Pub. Date: Jul. 28, 2005

(54) Systems and methods for selective power transfer

(76) Inventor: Haso Peljto, Brooklyn Park, MN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/034,902

(22) Filed: Jan. 13, 2005

Related U.S. Application Data
(60) Provisional application No. 60/536,382, filed on Jan. 14, 2004.

(51) Int. Cl. G05D 3/12

(52) U.S. Cl. 700/291

(57) ABSTRACT

Systems and methods according to preferred embodiments of the present invention may include the steps of and associated hardware and other interconnected devices for determining the relative cost of energy at an origination point; determining the relative cost of energy at a destination point; comparing the cost of energy at the origination point with the cost of energy at the destination point taking into account the transmission losses; and purchasing energy from the origination point if the cost of energy at the origination point plus transmission losses are substantially less than the cost of energy at the destination point.

### CROSS REFERENCE TO RELATED APPLICATIONS

This application claims the benefit of United States Provisional Patent Application entitled “LMP Dependent Transaction Curtailment” filed Jan. 14, 2004, Ser. No. 60/536,382 which is hereby incorporated by reference in its entirety.

### BACKGROUND OF THE INVENTION

The present invention relates generally to power distribution systems, and more particularly to power distribution systems that may selectively seek and acquire power from external sources taking into account the cost the external power relative to the origination and distribution points.

Electrical power distribution systems are well known in modern society. Since the beginning of the twentieth century, alternating-current (AC) power distribution systems have been providing both industrial and residential customers with power necessary to run their electrical devices.

To supply the ever-increasing demand for power, sophisticated power distribution networks have emerged. These networks are typically arranged to supply power over a certain geographical area, and are considered to be “separate” from one another in that specific power companies own the distribution facilities in these areas and are responsible for developing and maintaining the associated generating plants and distribution network.

The demand for electricity within a particular service area may vary substantially at certain times. Often, many utility companies are unable to generate enough electricity through internal generation means to meet customer demand. Because of the enormous capital and environmental costs associated with building new power plants, utility companies often purchase electrical power from neighboring distribution networks to supplement their power reserves rather than build new expensive generation facilities that may frequently remain unused.

However, the cost of power from other networks may vary greatly. If the cost of the additional power plus the loss suffered over the transmission network is greater than the sale price extended to the customer, the utility will undesirably lose money by buying power from this network. In addition, in some circumstances, other utilities may offer to sell power at low enough prices that it makes economic sense for a neighboring utility to buy that power and provide it to their customers. Moreover, a particular utility usually has access to several external transmission networks from which it may buy power. In this case, it would be desirable to be able to determine which distributor is offering the best price (in view of transmission losses and certain constraints imposed by congestion) and buy the power from that vendor.

Accordingly, in view of the foregoing, it would be desirable to provide systems and methods that allow a utility company to determine the relative price of power purchased from a certain vendor.

It would be further desirable to provide systems and methods that allow a utility company to automatically determine whether to purchase power from a certain vendor with respect to the relative profitability of such a transaction.

### SUMMARY OF THE INVENTION

It is therefore an object of the present invention to provide systems and methods that allow a utility company to determine the relative price of power purchased from a certain vendor.

It is therefore an object of the present invention to provide systems and methods that allow a utility company to automatically determine whether to purchase power from a certain vendor with respect to the profitability of such a transaction.

These and other objects of the invention are provided in accordance with the principles of the present invention by providing systems and methods that allow a utility company to determine the relative price of power purchased from a certain vendor.

Methods according to preferred embodiments of the present invention may include determining the relative cost of energy at an origination point; determining the relative cost of energy at a destination point; comparing the cost of energy at the origination point with the cost of energy at the destination point taking into account the transmission losses; and purchasing energy from the origination point if the cost of energy at the origination point plus transmission losses are substantially less than the cost of energy at the destination point.

Systems according to preferred embodiments of the present invention may include a plurality of selectively interconnectable energy distribution networks for distributing electrical power to consumers; controller circuitry associated with at least one network in the plurality of networks for detecting and fulfilling power deficiencies within the at least one network where the controller circuitry is configured to determine the relative cost of electrical power at an external point; determine the relative cost of electrical power within the at least one network; compare the cost of electrical power from the external point with the cost of electrical power within the at least one network; and transfer electrical power from the external point if the cost of the power at the external point plus transmission losses are substantially less than the cost of power in the at least one network.

### BRIEF DESCRIPTION OF THE DRAWINGS

The above and other objects and advantages of the present invention will be apparent upon consideration of the following detailed description, taken in conjunction with the accompanying drawings, in which like reference numbers refer to like parts throughout, and in which:

FIG. 1 shows a generalized block diagram of a system constructed in accordance with the principles of an embodiment of the present invention for selectively transferring electrical power from one distribution network to another;

FIG. 2 is a block diagram of a multi-conductor transmission system; and

FIG. 3 is flow chart illustrating some of the steps involved in evaluating and selectively transferring power from one distribution network to another in accordance with the principles of one embodiment of the present invention.

### DETAILED DESCRIPTION OF THE INVENTION

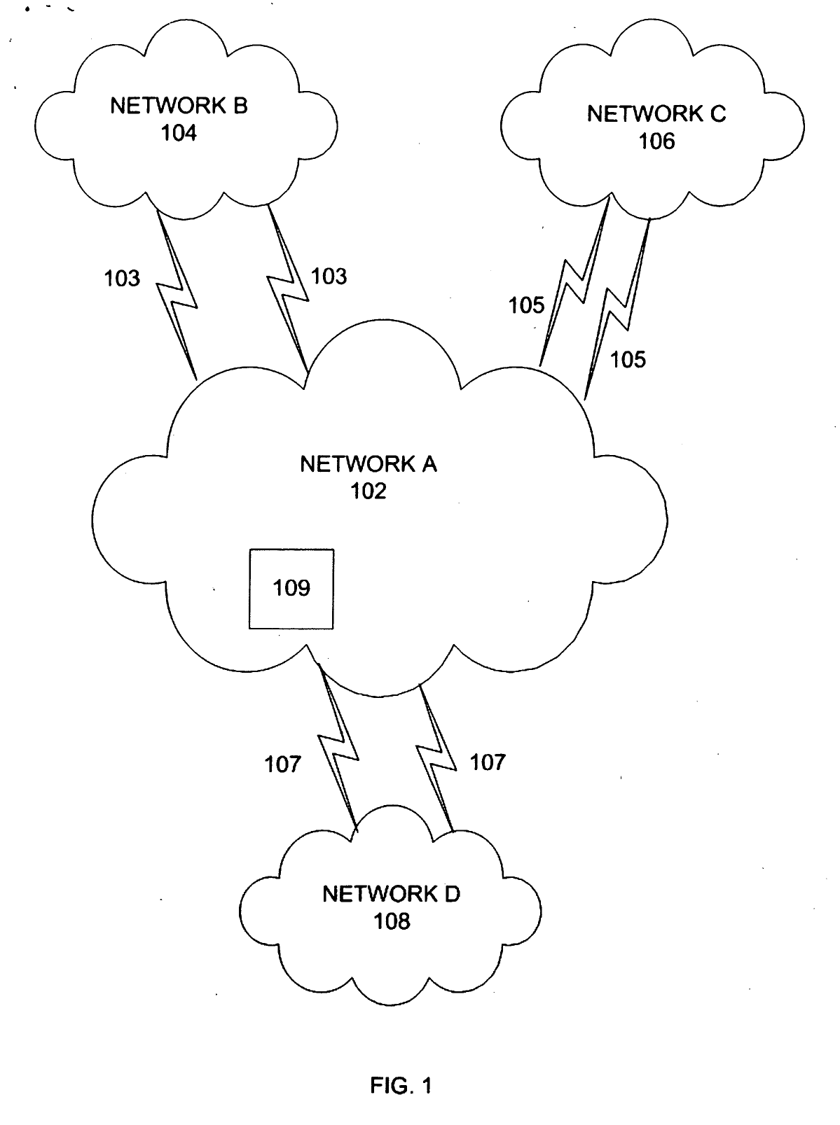

FIG. 1 shows a generalized diagram of a system 100 that provides power distribution over various geographical areas. For example, as shown, network A, network B, network C, and network D (labeled as network 102, 104, 106, and 108 respectively) may be any suitable power distribution network that provides electrical power to users over different geographic areas (e.g., a three phase power distribution network).

Although not specifically depicted in FIG. 1, networks 102-108 may include power generators such as turbines, power distribution and transfer mediums such as transmission lines, and other items normally associated with power distribution systems such as transformers. In addition, although networks 102-108 are shown as adjacent to one another, in some embodiments, these networks may be physically remote.

As shown, networks 102-108 may be coupled to one another through transmission conduits 103-107. Such conduits may include the circuitry necessary to selectively connect networks 104-108 to network 102 to transfer power. For example, conduits 103-107 may generally include switches and associated control circuitry as well as conductors adapted for transferring power from one network to another (not specifically shown). Such switches and control circuitry may be controlled by a control system present in one or more of the networks. For example, as shown in FIG. 1, controller 109 in network 102 may control certain circuitry (not shown) in the conduits to make or break connections to the external networks.

In some embodiments, conduits 103-107 may merely be conductors, with the switches required to effect a connection remaining within each network. With this configuration, each network may control its own internal switches such that sets of switches within both networks may need to be closed to create a connection. For example, assume network 102 and network 108 are to be connected. With this configuration, controller 109 may direct closure of certain switches within network 102 (which connects to conduit 107) and control circuitry in network 108 (not shown) may close certain switches to connect it to conduit 107 on the opposite side thereby connecting networks 102 and 108. This configuration allows each network involved (i.e., 102 and 108) to independently terminate the connection if desired or necessary (e.g., overload, power transfer complete, etc.).

In operation, networks 102-108 typically operate substantially independent of one another. Under certain circumstances, however, each network may desire to buy, sell or otherwise transfer power to other networks depending on operating conditions. For example, if the load on a particular network is lower than normal, that network may have excess power (or capacity available to generate additional power) and may desire to sell or transfer that power to another network in order to maintain or increase profits. Network operators may forecast this additional availability and advertise in advance that surplus power will be available for sale in the market (and in some instances post an expected price and quantity).

At a similar point in time, another network may be experiencing a load greater than expected and needs to find additional power through neighboring networks or by bringing additional generation facilities online (which may be cost prohibitive in the short term). This need may also be forecasted and advertised for the purpose of seeking a power supplier (and the best available price for that power).

Assuming for the sake of illustration that network 108 has or is expecting to have additional power (or capacity) and network 102 is experiencing (or is expecting to experience) higher than normal loads. Once the availability of network 108 exceeds or is expected to exceed a preset threshold, it may communicate with other networks and/or a centralized marketplace, information regarding the surplus (e.g., amount, time available, price). Network 102 may receive this information, and an agreement may be reached whereby network 102 purchases some or all of the surplus from network 108 to satisfy its additional demand.

Thus, in operation, network 108 may connect to network 102 and receive the desired additional power. This may occur in the manner described above via conduit 107. However, network 102 may be limited by additional system parameters that make it impractical or undesirable to satisfy its power need from network 108. For example, the price of power offered by network 108 may be higher than the price that can be charged to consumers in network 102, making such a transaction undesirable. System congestion, such as loop backs or indirect power flow, and transmissions constraints, such as insufficient or indirect distribution resources may make it difficult or impossible for the amount of power desired to be transferred from network 108 to network 102. Moreover, other suppliers available to network 102 (e.g., networks 104 and 106) may be offering the same or similar surplus at better terms.

Taking these and other considerations into account, network 102 constructed in accordance with the principles of the present invention may analyze these and a number of additional factors in deciding which external network to purchase additional power from (if any at all). As mentioned above, one factor in this decision includes price. Ideally speaking, the price of power offered by an external network would be less than the production cost realized in network 102.

However, in practice this is frequently not the case. Therefore, network 102 through controller 109 may determine or otherwise receive power pricing from an external network or marketplace such as the LMP price (location-based marginal pricing) and make a comparison to its own cost structure to determine if price offered from the other network is favorable.

Another factor that may be considered in addition to price comparison is transmission loss. This may be calculated (or estimated) and added to the purchase cost of the power to determine the actual cost of buying and delivering power to the consumer. For example, if the cost of 100 MW of power is one dollar per MW, and the loss factor due to transmission is one percent, the buyer is actually paying one hundred dollars for 99 MW of power, or 1.01 dollars per MW.

Other constraints such as system congestion may also be considered in choosing a power vendor. For example, in conducting a cost-based analysis, several external vendors may be located offering the lowest price. However, after considering the path through which the power must travel, it is determined that the transmission lines cannot handle the contemplated transfer without an unacceptable risk of damage or failure and rerouting is not a cost effective or practical option. In these cases, such vendors are typically excluded as potential providers. Other congestion or transmission related problems such as indirect routing and fanout may also prevent the lowest bidder from providing the sought power.

Generally speaking, power may be provided to network 102 in accordance with three general guidelines:
1) If the cost of external power plus transmission loss is less than internal costs, transfer the desired amount of power required;
2) If the cost of the external power plus transmission loss is equal to internal costs, transfer an amount of power less than the required amount; and
3) If the cost of the external power plus transmission loss is greater than internal costs, prohibit any power transfer.

It will be understood that these guidelines are merely exemplary, and may be modified or circumvented under certain circumstances. For example, if network 102 was in danger of suffering a complete loss of service to overload (i.e., blackout), power may be accepted from neighboring networks regardless of price or other condition. This may also hold true for situations that may result in damage to the network infrastructure (i.e., brownout or severe power drop).

Furthermore, these guidelines may be customized to meet a certain user's needs while remaining within the spirit and scope of the present invention. For example, condition 1 above may be modified such that the desired amount of power is transferred only if the cost of that power is a predetermined amount below internal costs. Condition 2 may be modified such that the decision point is “substantially equal to” (i.e., slightly above or slightly below) rather than exactly equal to with the amount of power purchased dependent on the differential.

For example, if the cost of power is slightly below the equality point, a larger percentage of required power may be purchased than if the cost is exactly equal to or slightly above. In addition, condition 2 may be modified such that power is purchased on a “sliding scale” such that the amount of power purchased around the equality point is function of price set by network management. For example, with one possible scale, if the cost of external power is exactly equal to cost, no more than 50% of the required power would be purchased. And if the cost of external power was 1% more than internal cost, not more than 10% of the required power may be purchased, etc. Any such suitable modification or qualification of this condition may be implemented if desired.

Condition 3 may also be modified to meet certain requirements. For example, condition 3 may be modified such that power is not purchased when its cost exceeds a certain threshold (e.g., 10% above internal cost). Any other suitable modification may be implemented if desired.

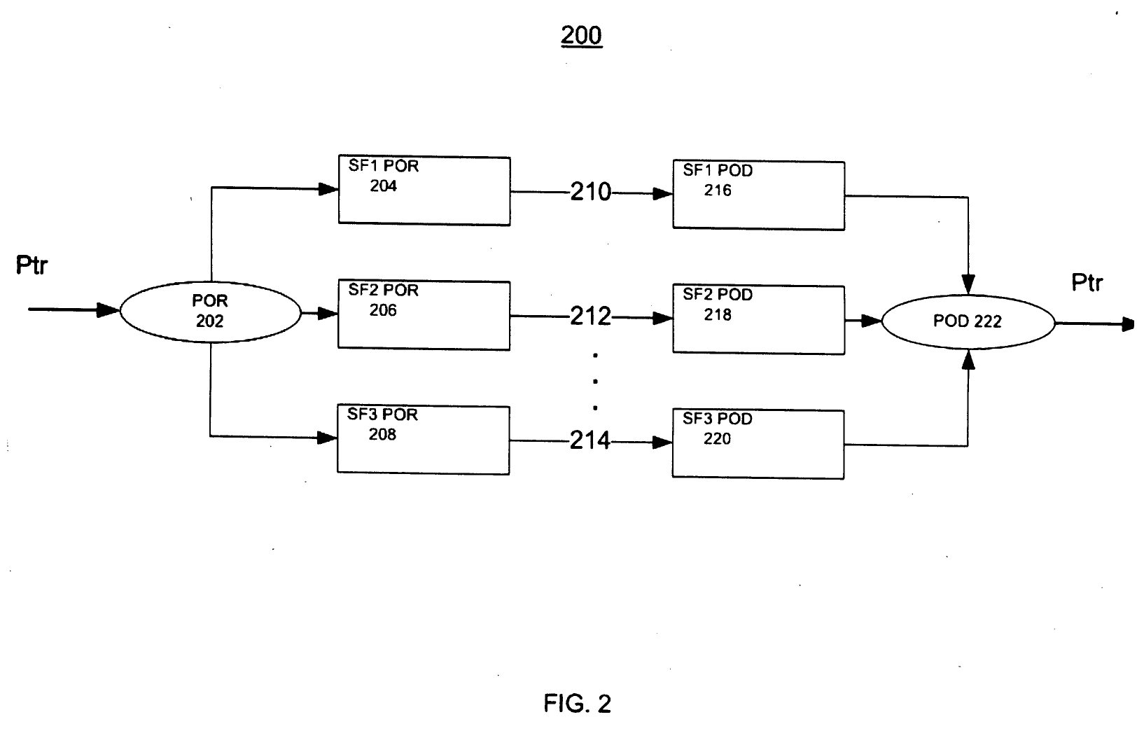

In some embodiments of the invention, power may be distributed over many different transmission lines. FIG. 2 generally illustrates one such system 200 which may transfer power over n transmission lines. System 200 may generally be viewed as line diagram or transmission model of the transmission path that power being transferred from one distribution network to another may travel on.

As depicted in FIG. 2, system 200 may generally include a point of origin 202 (POR), which may represent the point from which power is being supplied from, various scaling factor circuitry 204-208 (such as transformers) on the transmission side, each being associated with a transmission line 210-214. Similarly, the point of destination (POD) 222, to which power is being supplied may also include scaling factor circuitry 216-220 to receive power from each transmission line.

The transaction influence of power flow across a given transmission line (in this case line 210) may be expressed as a linearized line flow given in equation 1 below where:
P₂₁₀=P₂₁₀(P_{gen})+(SF₁^{POR}−SF₁^{POD})×Pₜᵣ (1)

Where Pₜᵣ is the power transferred from one network to another and SF₁^{POR} and SF₁^{POD} represent respectively the scaled power transferred from the point of origin 202 of the power and the point of destination of the power 222. Moreover, system power balance may be expressed as shown in equation 2 below:
Sysload=sum(P_{gen}/PenFac_{gen})+Pₜᵣ/PenFacₜᵣ^{POR}−Pₜᵣ/PenFacₜᵣ^{POD} (2)

With a system such as the one generally described above, power may be bought and sold in accordance with the guidelines set forth above. This may be done by treating POR points as generation points and POD points as load points for calculation purposes. Network controllers, such as controller 109 (shown in FIG. 1) constructed in accordance with the principles of the present invention, may determine the LPM value of power at both the POR and POD points taking into account estimated transmission losses and make power purchase decisions based on the results of those calculations.

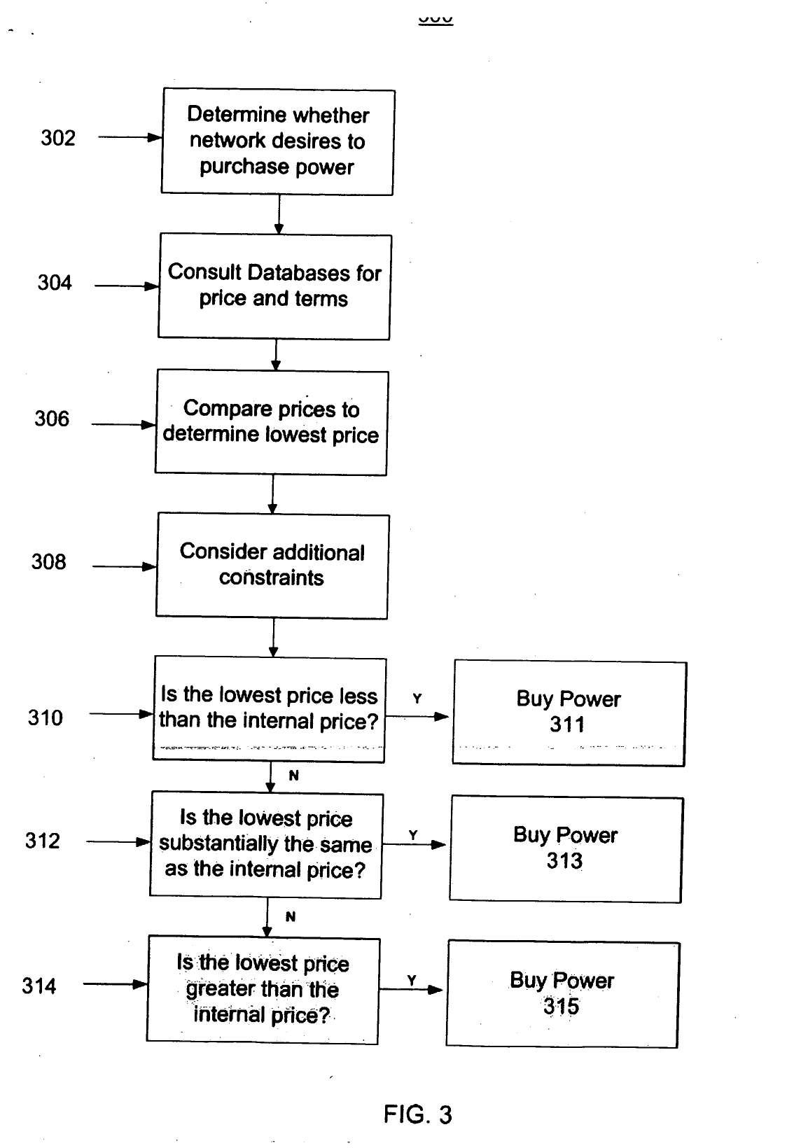

The flow chart 300 of FIG. 3 shows some of the steps that may be involved in evaluating and selectively transferring power from one distribution network to another.

At step 302, the power status of a particular distribution network may be evaluated to determine whether additional power is needed to satisfy existing or upcoming demand. If additional power is needed, continue to step 304. If additional power is not needed, the network may be evaluated to determine if a surplus exists. If so, this surplus may be reported to a central power market or otherwise be made known to other partner networks for possible resale.

At step 304, power markets may be consulted to determine the availability of external power, including key terms such as price, quantity, relative location, etc. In some embodiments, this step may include calculating (or merely analyzing) the LMP values for the point of origin (the “seller” network) and the point of destination (the “buyer” network).

Next, at step 306, these prices may be compared to determine the lowest prices for the power sought for purchase. This may include sorting potential suppliers by ascending or descending price values in order to quickly navigate the marketplace. It may also include a calculation or estimation of transmission losses to determine costs including delivery charges.

At step 308, after the lowest cost vendor is identified, additional constraints may be considered. For example, the transmission path and/or congestion factors associated with transmission of the contemplated power transfer from a potential vendor may be analyzed. If significant problems are identified, such insufficient transmission conductors, excessive fanout or indirect routing, certain vendors may be removed from the list, despite having the lowest price. Step 308 may be performed in an iterative fashion until a seller capable of providing power is found (or until the list of vendors is exhausted).

Next, at step 310, the price of available external power may be compared with the internal cost of generating power. If it is determined that the external price is less than the internal price, authorization may be given to buy the needed amount at step 311. This may accomplished a described above in connection with FIG. 1. The exact amount of power purchased, however, in a particular system may be determined based on criteria established by the user (e.g., some or all the needed amount depending on how favorable the price is, etc.).

If, at step 312, it is determined that the lowest external price is substantially equal to the existing price authorization may be given to buy a certain amount at step 313. The exact amount of power purchased, however, may be determined based on criteria established by the user as described above (e.g., based on a sliding scale depending on how favorable the price is).

If, at step 314, it is determined that the lowest external price is greater than the existing internal price, power transfer may be prohibited or curtailed (step 315). However, some power may be purchased even with this result depending on how great the differential is between the two price levels. If the price differential is relatively small, some power may be purchased. However, as the differential becomes more significant, the less likely it is a transfer will occur. Whether or not any power purchased, however, may be determined based on criteria established by the user as described above (e.g., based on a sliding scale depending on how unfavorable the price is, etc.).

It will be understood from the above that these steps may be performed by controller 109, processing circuitry within controller 109, or by other hardware and/or software combination external to or in conjunction with controller 109.

From a systems organization standpoint, it will be understood that aspects of the invention can be located or installed on a server, workstation, minicomputer, or mainframe. For example, controller 109 may be a part of a general purpose computer with the databases stored in memory associated with the general purpose computer. One or more input and/or output (I/O) devices (or peripherals) may be communicatively coupled via a local interface. The local interface may be, for example, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connection to enable appropriate communications among the components of a network. The systems and methods may be hardwired with the computer to allow it to perform various aspects of the invention.

The systems and methods described herein may also be incorporated in software used with a computer resident within or external to controller 109. The software may be stored or loaded in memory and may include one or more separate programs, each of which comprises an ordered listing of executable instructions for implementing the methods and systems of the invention. The software may work in conjunction with an operating system. The operating system essentially controls the execution of the computer programs, such as the software stored within the memory, and provides scheduling, input-output control, file and data management, memory management, and communication control and related services. The system and method may also include a Graphic User Interface (GUI) to allow the user to edit variables or the various constraints (such as price levels and other thresholds associated with power purchasing decisions). The GUI may provide a user-friendly interface that allows a user to enter model data and calculate startup costs for experiential data.

Thus, systems and methods for selective power transfer are provided. It will be understood that the foregoing is only illustrative of the principles of the invention and that various modifications can be made by those skilled in the art without departing from the scope and spirit of the invention. For example, the steps described above are only illustrative, and it will be understood that these steps are not meant to be comprehensive (others can be added, if desired) and can be performed in orders other than the one shown. Accordingly, such embodiments will be recognized as within the scope of the present invention.

Persons skilled in the art will appreciate that the present invention can be practiced by other than the described embodiments, which are presented for purposes of illustration rather than of limitation and that the present invention is limited only by the claims that follow.

1. In an energy market environment, a method for determining whether to purchase energy from an external source comprising:
determining the relative cost of energy at an origination point;
determining the relative cost of energy at a destination point;
comparing the cost of energy at the origination point with the cost of energy at the destination point taking into account transmission losses; and
purchasing energy from the origination point if the cost of energy at the origination point plus transmission losses are substantially less than the cost of energy at the destination point.

2. The method of claim 1, wherein the purchasing step further comprises purchasing a maximum amount of energy if the cost of energy at the origination point plus transmission losses are less than the cost of energy at the destination point.

3. The method of claim 1, further comprising purchasing/transferring some energy if the cost of energy at the origination point plus transmission losses are substantially equal to the cost of energy at the destination point.

4. The method of claim 3, wherein the amount of power purchased is a function of price.

5. The method of claim 1, further comprising curtailing energy if the cost of energy at the origination point plus transmission losses are substantially greater the cost of energy at the destination point.

6. The method of claim 1, wherein the comparing further includes comparing energy prices supplied from an energy marketplace.

7. The method of claim 1, wherein the comparing further includes employing a sliding scale analysis in order to determine whether to purchase power.

8. The method of claim 1, wherein the decision to purchase energy from the purchase point includes a constraint analysis

9. The method of claim 8, wherein the constraint analysis includes analyzing capacity of a conducting path through which purchased power may be transmitted.

10. The method of claim 8, wherein the constraint analysis includes analyzing system congestion through which purchased power may be transmitted.

11. The method of claim 1, wherein the threshold at which energy is purchased is set by the customer.

12. The method of claim 1, wherein cost of energy is calculated using LMP pricing.

13. In an energy market environment, a system for determining whether to transfer energy from one distribution network to another comprising:
a plurality of selectively interconnectable energy distribution networks for distributing electrical power to consumers;
controller circuitry associated with at least one network in the plurality of networks for detecting and fulfilling power deficiencies within at least one network wherein the controller circuitry is configured to:
determine the relative cost of electrical power at an external point;
determine the relative cost of electrical power within the at least one network;
compare the cost of electrical power from the external point with the cost of electrical power within the at least one network; and
transfer electrical power from the external point if the cost of the power at the external point plus transmission losses are substantially less than the cost of power in the at least one network.

14. The system of claim 13, wherein the controller circuitry includes algorithms and user defined parameters for purchasing energy, wherein the algorithms and user defined parameters include determining if the cost of energy at the origination point plus transmission losses are less than the cost of energy at the destination point.

15. The system of claim 13, wherein the controller circuitry causes the purchase/transfer of energy if the cost of energy at the origination point plus transmission losses are substantially equal to the cost of energy at the destination point.

16. The system of claim 15, wherein the amount of power purchased/transferred is a function of price.

17. The system of claim 13, wherein the controller circuitry further includes curtailing the purchase/transfer of energy if the cost of energy at the origination point plus transmission losses are substantially greater the cost of energy at the destination point.

18. The system of claim 13, wherein the controller circuitry further includes comparing energy prices supplied from an energy marketplace.

19. The system of claim 18, wherein the comparing further includes employing a sliding scale analysis in order to determine whether to purchase power.

20. The system of claim 13, wherein the controller circuitry further includes a decision analysis to determine whether to purchase energy from the purchase point; wherein the decision analysis includes a constraint analysis

21. The system of claim 20, wherein the constraint analysis includes analyzing capacity of a conducting path through which purchased power may be transmitted.

22. The system of claim 20, wherein the constraint analysis includes analyzing system congestion through which purchased power may be transmitted.

23. The system of claim 13, wherein the controller circuitry further includes using LMP pricing to calculate the cost of energy.
